(19) United States
(12) Patent Application Publication
(10) Pub. No.: US 2024/0389043 A1
(43) Pub. Date: Nov. 21, 2024

(54) MITIGATION OF PERFORMANCE DEGRADATION

(71) Applicant: Nokia Technologies Oy, Espoo (FI)

(72) Inventors: Lars DALSGAARD, Oulu (FI); Lei DU, Beijing (CN); Yueji CHEN, Hangzhou (CN)

(21) Appl. No.: 18/686,686

(22) PCT Filed: Aug. 27, 2021
(86) PCT No.: PCT/CN2021/115153

§ 371 Date: Feb. 26, 2024

(51) Int. Cl. H04W 56/00; H04W 24/10

(52) U.S. Cl. CPC H04W 56/0055; H04W 24/10

(57) ABSTRACT

Embodiments of the present disclosure relate to devices, methods, apparatuses and computer readable storage media of mitigation of performance degradation for improved system performance. The method comprises determining receive timing difference between a serving cell of the first device and a target cell, the serving cell being located on a first carrier, the target cell being located in a second carrier; and determining to report an indication associated with the receive timing difference to the second device. In this way, the network may be aware of experience performance degradation of the UE due to a large RTD without increasing the network complexity. Meanwhile, the TP performance of the UE may be improved.

### FIELD

Embodiments of the present disclosure generally relate to the field of telecommunication and in particular to devices, methods, apparatuses and computer readable storage media of mitigation of performance degradation.

### BACKGROUND

The Maximum Receive Timing Difference (MRTD) requirements for the User Equipment (UE) have been discussed for the Frequency Range 2 (FR2) inter-band Carrier Aggregation (CA). It has been agreed that the MRTD for inter-band CA in FR2 which the UE shall be able to cope with will be 3 μs e.g. for a UE capable of Common Beam Management (CBM). Similar requirements have also already been defined for a UE capable of independent Beam Management (IBM).

In short, a UE capable of FR2 inter-band CA and IBM can operate the UE Receiving (Rx) beams in each band independently of each other based on the beam management (BM) Reference Signal (RS) received in each band. A UE capable of FR2 inter-band CA and CBM can only operate with one common UE Rx beam and the same common Rx beam in all bands, where the BM RS used is received in one of the bands.

### SUMMARY

In general, example embodiments of the present disclosure provide a solution of mitigation of performance degradation.

In a first aspect, there is provided a first device. The first device comprises at least one processor; and at least one memory including computer program codes; the at least one memory and the computer program codes are configured to, with the at least one processor, cause the first device at least to determine receive timing difference between a serving cell of the first device and a target cell, the serving cell being located on a first carrier, the target cell being located in a second carrier; and determine to report an indication associated with the receive timing difference to the second device.

In a second aspect, there is provided a second device. The second device comprises at least one processor; and at least one memory including computer program codes; the at least one memory and the computer program codes are configured to, with the at least one processor, cause the second device at least to in accordance with a determination that an indication associated with the receive timing difference between a serving cell of a first device and the target cell is received from the first device, determine an availability of the target cell based on the indication, the serving cell being located on a first carrier, the target cell being located in a second carrier.

In a third aspect, there is provided a method. The method comprises determining receive timing difference between a serving cell of the first device and a target cell, the serving cell being located on a first carrier, the target cell being located in a second carrier; and determining to report an indication associated with the receive timing difference to the second device.

In a fourth aspect, there is provide a method. The method comprises in accordance with a determination that an indication associated with the receive timing difference between a serving cell of a first device and the target cell is received from the first device, determining an availability of the target cell based on the indication, the serving cell being located on a first carrier, the target cell being located in a second carrier.

In a fifth aspect, there is provided an apparatus comprising means for determining receive timing difference between a serving cell of the first device and a target cell, the serving cell being located on a first carrier, the target cell being located in a second carrier; and means for determining to report an indication associated with the receive timing difference to the second device.

In a sixth aspect, there is provided an apparatus comprising means for in accordance with a determination that an indication associated with the receive timing difference between a serving cell of a first device and the target cell is received from the first device, determining an availability of the target cell based on the indication, the serving cell being located on a first carrier, the target cell being located in a second carrier.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example environment in which example embodiments of the present disclosure can be implemented;

FIG. 2 shows a signaling chart illustrating a process of mitigation of performance degradation according to some example embodiments of the present disclosure;

FIG. 3 shows a flowchart of an example method of mitigation of performance degradation according to some example embodiments of the present disclosure;

FIG. 4 shows a flowchart of an example method of mitigation of performance degradation according to some example embodiments of the present disclosure;

FIG. 5 shows a simplified block diagram of a device that is suitable for implementing example embodiments of the present disclosure; and

FIG. 6 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future.

Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

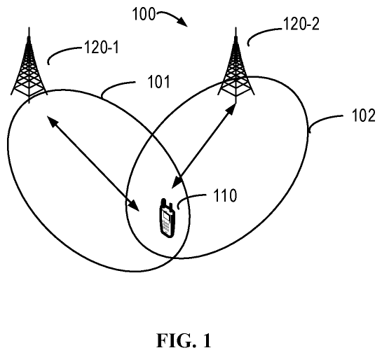

FIG. 1 shows an example communication network 100 in which embodiments of the present disclosure can be implemented. As shown in FIG. 1, the communication network 100 may comprise a terminal device 110 (hereinafter may also be referred to as a UE 110 or a first device 110). The communication network 100 may further comprise a network device 120-1 (hereinafter may also be referred to as a gNB 120 or a second device 120). The communication network 100 may also comprise a further gNB 120-2. The terminal device 110 and the network device 120-1 can communicate with each other in the coverage of the cell 101 and the terminal device 110 and the network device 120-2 can communicate with each other in the coverage of the cell 102. In some example embodiments, the cell 101 may act as a serving cell of the terminal device 110 and the cell 102 may act as a serving cell, a cell used for scheduling, a neighbor cell or a target cell associated with CA.

It is to be understood that the number of network devices and terminal devices shown in FIG. 1 is given for the purpose of illustration without suggesting any limitations. The communication network 100 may include any suitable number of network devices and terminal devices.

As described above, the MRTD requirements for the UE have been discussed for FR2 inter-band CA. It has been agreed that the MRTD for inter-band CA in FR2 under CBM is 3 μs. For the receive timing difference (RTD) below a threshold “X” μs, no performance degradation is expected. For the receive timing difference equal or higher than the threshold “X” μs, a performance degradation may be allowed.

Furthermore, no requirements have yet been defined for the UE capable of FR2 inter-band CA with common beam management (CBM), while for UE capable of FR2 inter-band CA and IBM, the UE shall be capable of handling at least a relative receive timing difference between slot timing of all pairs of carriers to be aggregated at the UE receiver as shown below.

TABLE 1
MRTD requirement for inter-band NR CA

| Frequency Range of | Maximum receive timing |
|---|---|
| the pair of carriers | difference (μs) |
| FR1 | 33 |
| FR2 | 8 ^{note1} |
| Between FR1 and FR2 | 25 |

^{Note1}:
This requirement applies to the UE capable of independent beam management for FR2 inter-band CA.

As mentioned above, it is clear that the UE performance is only guaranteed without negative impact for RTD up to the threshold “X” μs. If the observed receive timing difference (RTD) (hereinafter may also be referred to as an experienced RTD of UE) exceeds the MRTD threshold “X” μs, the UE may be allowed some performance degradation.

When the requirements defined for the UE capable of CBM is considered, an example of MRTD requirement for inter-band FR2 NR CA can be shown as below.

TABLE 2
MRTD requirement for inter-band NR CA

| Frequency Range of | Maximum receive timing |
|---|---|
| the pair of carriers | difference (μs) |
| FR1 | 33 |
| FR2 | 8 ^{note1} |
| FR2 | 3 ^{note2} |
| Between FR1 and FR2 | 25 |

^{Note1}: This requirement applies to the UE capable of independent beam management for FR2 inter-band CA.
^{Note2}: This requirement applies to the UE capable of common beam management for FR2 inter-band CA. If the receive timing difference exceeds [X] of that SCS, demodulation performance degradation is expected for the first or last symbol of the slot in the band where beam management reference resource(s) is not configured, where X is defined in Table 7.6.4.3.

Furthermore, the Threshold X for FR2 inter-band CBM capable UE can be shown as below.

TABLE 3
The Threshold X for FR2 inter-band CBM capable UE

| Sub-carrier | | T_{beam}, UE Rx | |
|---|---|---|---|
| spacing in PCell | T_{cp}, CP length | Beam switch time | X (T_{cp} − T_{beam}) |
| (kHz) | (μs) | (μs) | (μs) |
| 60 | 1.17 | [TBD] | [1.17 − TBD] |
| 120 | 0.59 | [TBD] | [0.59 − TBD] |

It can be seen that the performance degradation may happen based on the UE experienced RTD value which depends on the deployment scenario and the location of the UE. The network can configure the UE with FR2 inter-band CA accounting the deployment scenario and the UE will be able to cope with RTD of up to 3 μs. The UE experienced RTD may be below or above the threshold X, which marks the threshold where UE performance degradation may start to occur.

But the network will not always be able to know the actually experienced RTD on the UE side. In some situations, for example, based on the UE location relative to the cells used in the CA configuration, a first UE may experience that RTD is below the threshold X while a second UE may experience that RTD is above the threshold X. In such case, the first UE will not be allowed or experience performance degradation while the second UE is allowed or may experience some performance degradation.

The network may experience or observe a performance difference or degradation in terms of, for example, lower throughput (TP) for the second UE. Based on this experienced lower TP for the second UE, the network may de-configure the second UE such that it is no longer configured with CA.

However, such approach will be based on network experienced/tracked performance degradation of the second device. This means that during the tracking time (during which the possible degradation is evaluated) there will be potential performance loss and hence loss of radio resource and UE power. Additionally, network identification of the performance loss may increase the network complexity.

It should also be mentioned that it is expected that different UE implementation architectures are expected to perform differently maybe even under the same conditions in terms of experienced performance degradation-even under same RTD conditions. Hence, some UE implementations will be more robust against RTD and will not experience performance degradation if RTD exceeds X but potentially only after being exceeded with another threshold higher than the X. Other UE implementation may experience impact when RTD exceeds X.

Besides the currently discussed inter-band CA scenario (FR2) there are other situations which may cause similar challenges. Both non-co-located gNBs used in inter-band CA and non-CA/DC scenarios such as inter-cell Multiple Input Multiple Output (MIMO)/Transmission and Reception Point (TRP) reception and/or LI mobility may also be considered for covering future deployment. Also other examples where UE is receiving from more cells and/or TRPs from same or different cells on same or different carriers are also possible.

For the network side, the challenge is how to account in an efficient manner the UEs which experience performance degradation due to large RTD. Other challenge is UE TP performance and optimizing this accounting the used UE power.

Therefore, the present disclosure provides solutions of mitigation of performance degradation. In this solution, the UE may determine receive timing difference between a serving cell of the first device and a target cell, the serving cell being located on a first carrier, the target cell being located in a second carrier and determine to report an indication associated with the receive timing difference to the second device. In this way, the network may be aware of experience performance degradation of the UE due to a large RTD without increasing the network complexity. Meanwhile, the TP performance of the UE may be improved. The target cell may be a neighbour cell or a serving cell. The target cell may be located on the same first carrier as the serving cell.

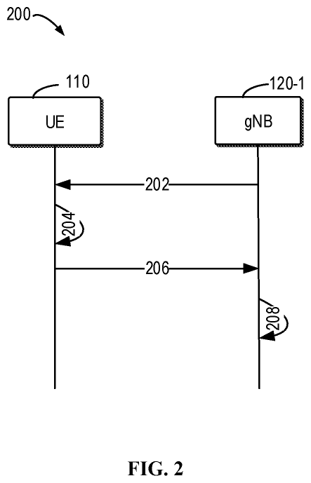

Principle and implementations of the present disclosure will be described in detail below with reference to FIG. 2, which shows a signaling chart illustrating a process 200 of mitigation of performance degradation according to some example embodiments of the present disclosure. For the purpose of discussion, the process 200 will be described with reference to FIG. 1. The process 200 may involve the UE 110 and the gNB 120-1.

In some example embodiments, the UE 110 may be served by a serving cell of the gNB 120-1. The serving cell may be located in a first carrier. The UE 110 may be configured with CA with the serving cell of the gNB 120-1 and another cell located in the second carrier. In this scenario, the serving cell may also be referred to as a primary cell and another cell may also be referred to as a secondary cell. It is to be understood that the first carrier and the second carrier may be referred to as a same carrier or different carriers. It is to be understood that the serving cell and another cell may not be configured in CA.

In some example embodiments, the gNB 120-1 may expect the UE 110 to evaluate the RTD between the serving cell and a target cell of a gNB 120-2 (as shown in FIG. 1) located in a second carrier. The gNB 120-1 may also expect that the UE 110 report the evaluate RTD to the gNB 120-1.

As shown in FIG. 2, the gNB 120-1 may transmit 202 configuration information of the target cell to the UE 110. The configuration information may be referred to as measurement configuration of the target cell or any other suitable types of configuration. In some example embodiments, the gNB 120-1 may indicate the UE 110 to report the RTD between the serving cell and a target cell to the gNB 120-1. As another option, the gNB 120-1 may indicate the UE 110 to report the RTD between the serving cell and a target cell in some certain conditions. As another option, the gNB 120-1 may indicate the UE 110 to report the RTD status between the serving cell and a target cell in some certain conditions

Based on the configuration information, the UE 110 may perform the measurement for the target cell in the second carrier. For example, the UE 110 may measure a downlink reference signal, such as a synchronization signal block (SSB) or CSI-RS.

Furthermore, the UE 110 may also perform the measurements for reference signals received from other cells serving the UE 110, such as the serving cell of the gNB 120-1 or any other possible cells.

Based on the performed measurements, the UE 110 may evaluate 204 the RTD between the serving cell of the gNB 120-1 and the target cell.

In some example embodiments, if the UE 110 determines that the evaluated RTD exceeds a threshold RTD, the UE 110 may determine that the RTD impacts the UE performance negatively.

In some example embodiments, if the UE 110 determines that the evaluated RTD does not exceed threshold RTD, the UE 110 may determine that the RTD may not impact the UE performance.

In some example embodiments, it is to be understood that the threshold RTD may be a common threshold RTD predefined or configured by the network for all UEs. In some example embodiments, the threshold RTD may also be a threshold RTD specified for the UE 110. In some example embodiments, the threshold RTD can be determined by the UE 110.

In some example embodiments, the threshold value specified for or determined by the UE 110 may be located within a range between the predefined common threshold RTD and a predefined maximum RTD (MRTD) of the UE 110.

In some example embodiments, the threshold value specified for or determined by the UE 110 may be set to being not lower than a minimum threshold, e.g. 260 ns.

Then the UE 110 may determine whether the RTD status is to be reported to the gNB 120-1. Besides the trigger of reporting the RTD as mentioned above, a report may also be sent by UE, when RTD status is requested by the gNB 120-1 or the evaluated RTD does or does not exceed the threshold RTD. The UE 110 may also report the RTD status in a case where an intra-frequency and/or inter-frequency measurement before the target cell on the second carrier is being used in the CA. It is also possible that the UE 110 may report the RTD status in a case where the CA is configured for the UE 110, the target cell is configured for the UE 110 as a secondary cell for the CA or the target cell, e.g. a deactivated secondary cell, is being activated.

It is possible that the UE 110 may skip reporting the RTD status to the gNB 120-1 in a case where the evaluated RTD exceeds the threshold RTD. It is possible that the UE 110 may skip reporting the RTD status to the gNB 120-1 in a case where the evaluated RTD does not exceed the threshold RTD

If the RTD status is to be reported from the UE 110 to the gNB 120-1, the UE 110 may transmit 206 an indication reflecting the RTD status based on the evaluated RTD. In some example embodiments, an indication reflecting the RTD status may be an actual value of the evaluated RTD. In some example embodiments, the indication reflecting the RTD status may also be a report of potential impact due to performance degradation caused by the RTD status. In some example embodiments, the indication may reflect the RTD status as an indication whether or not the RTD exceeds the threshold RTD.

In some example embodiments, the UE 110 may report the RTD status along with the measurement result of the target cell, which has been performed based on the measurement configuration provided by the gNB 120-1

In some example embodiments, the reporting of the RTD status can be reported via various way. For example, the UE 110 may transmit the indication of the RTD status along with channel state information reporting for the serving cell or target cell. As another example, the UE 110 may transmit the indication of the RTD status along with a reporting associated with reference signal received power (RSRP) of the serving and/or target cell. In one example such as reporting low SS-RSRP or the low layer 1 (L1) reporting (L1-RSRP). It is also possible that the UE 110 may also transmit the indication of the RTD status as beam failure detection, radio link failure or indication or the layer 3 (L3) measurement report.

It is to be understood that the reporting of the RTD status can be triggered by any of event triggered reporting, event triggered period reporting, periodic reporting or similar.

After receiving the indication of the RTD status from the UE 110, the gNB 120-1 may determine 208 an availability of the target cell for use e.g. for the CA based on the indication. For example, if the indication indicating the RTD status may not impact the UE performance, the gNB 120-1 may use the target cell, configure and/or activate the target cell for inter-band FR2 CA. If the indication indicating the RTD status may lead to a degradation of the performance, the gNB 120-1 may choose not to configure or activate the target cell for inter-band FR2 CA. In some example embodiments, if the target cell is currently operating inter-band FR2 CA, the gNB 120-1 may de-configure or deactivate the target cell. It is to be understood that even if the description and embodiments are described using FR2, the solution disclosure in the present disclosure may also be used for other scenarios. For example, the solution disclosure in the present disclosure may also be applied for other scenarios than FR1 e.g. NR FR1, LTE and other wireless systems.

In some example embodiments, it is also possible that the gNB 120-1 may select to use the target cell, e.g., may add the target cell as the secondary cell for the inter-band FR2 CA in a case where the gNB 120-1 is aware of the performance degradation of the UE 110.

In some example embodiments, if the target cell is not chosen for the inter-band FR2 CA in a case where the RTD status exceeds a threshold RTD, the UE 110 may also continue to measure and track the target cell. If the UE 110 evaluates and observes that the RTD of the target cell is or become lower than the threshold value, the reporting of the status of the RTD of the target cell may also be triggered. Then the gNB 120-1 may select the target cell in a CA configuration based on the received status of the RTD of the target cell. In this case, the gNB 120-1 may assume that no UE performance degradation will happen.

In this way, the network may be aware of experience performance degradation of the UE due to a large RTD without increasing the network complexity. Meanwhile, the TP performance of the UE may be improved.

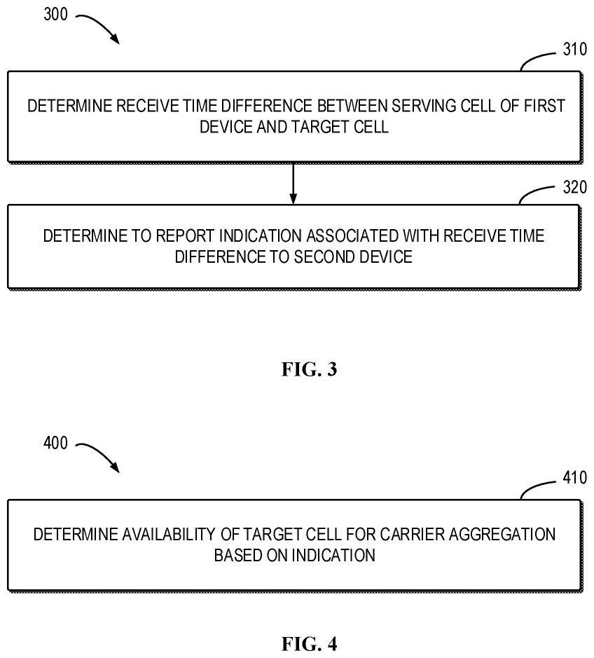

FIG. 3 shows a flowchart of an example method 300 of mitigation of performance degradation according to some example embodiments of the present disclosure. The method 300 can be implemented at the first device 110 as shown in FIG. 1. For the purpose of discussion, the method 300 will be described with reference to FIG. 1.

At 310, the first device determines RTD between a serving cell of the first device and a target cell. The serving cell is located on a first carrier and the target cell is be located a second carrier. The first carrier and the second carrier may be referred to as a same carrier or different carriers.

At 320, the first device determines to report an indication associated with the receive timing difference to the second device.

In some example embodiments, the first device may determine the indication associated with the receive timing difference is to be reported to the second device, in accordance with a determination of at least one of the following: an inter-frequency measurement or an intra-frequency measurement before the target cell on the second carrier is being used in a carrier aggregation is to be reported; a carrier aggregation is configured for the first device; the target cell is configured for the first device as a secondary cell; the target cell is being activated; the determined receive timing difference exceeds a threshold value; a request by the second device; and the determined receive timing difference is larger than, equal to or lower than the threshold value.

In some example embodiments, if the first device determines that the determined receive timing difference does not exceed a threshold value, the first device may cause the reporting of the determined receive timing difference to be skipped. If the first device determines that the determined receive timing difference exceeds a threshold value, the first device may cause the indication associated with the receive timing difference to be skipped. If the first device determines that the determined receive timing difference exceeds a threshold value, the first device may cause the measurement reports associated with the target cell not to be skipped.

In some example embodiments, the threshold value comprises at least one of the following: a predefined common threshold value, a threshold value specified for the first device, or and a threshold determined by the first device.

In some example embodiments, the threshold value specified for or determined by the first device is located within a range between the predefined common threshold value and a predefined maximum receive timing difference (MRTD) of the first device.

In some example embodiments, the threshold value specified for or determined by the first device is set to being not lower than a threshold e.g. than 260 ns.

In some example embodiments, the first device may generate the indication associated with receive timing difference comprising at least one of the following: a value of the determined receive timing difference, or an indication of potential impact due to performance degradation e.g. of a carrier aggregation or an indication that receive timing difference is above/below a threshold value.

In some example embodiments, the first device may transmit the indication associated with receive timing difference to the second device via at least one of the following: channel state information reporting for the target cell; a reporting associated with reference signal received power of the target cell; a beam failure detection or indication; or a layer 3 measurement report.

In some example embodiments, if the first device determines that the first device is indicated to report the receive timing difference, the first device may determine the receive timing difference.

In some example embodiments, the first device may receive a measurement configuration of the target cell from the second device; and determine the receive timing difference based on the measurement configuration.

In some example embodiments, the first device comprises a terminal device and the second device comprises a network device.

FIG. 4 shows a flowchart of an example method 400 of mitigation of performance degradation according to some example embodiments of the present disclosure. The method 400 can be implemented at the second device 120-1 as shown in FIG. 1. For the purpose of discussion, the method 400 will be described with reference to FIG. 1.

At 410, if the second device determines that an indication associated with the receive timing difference between a serving cell of a first device and the target cell is received from the first device, the second device determines an availability of the target cell based on the indication. The serving cell is located on a first carrier and the target cell is located on the first carrier or on a second carrier.

In some example embodiments, the second device may transmit a configuration e.g. a measurement configuration of the target cell to the first device.

In some example embodiments, the second device may obtain, from the indication, at least one of the following: a value of the determined receive timing difference, or an indication of potential impact due to performance degradation e.g. of a carrier aggregation; or an indication that receive timing difference is above/below a threshold value.

In some example embodiments, the second device may receive the indication via at least one of the following: channel state information reporting for the target cell; a reporting associated with reference signal received power of the target cell; a beam failure detection; or a layer 3 measurement report.

In some example embodiments, the second device may indicate the first device to report the receive timing difference to the second device.

In some example embodiments, the first device comprises a terminal device and the second device comprises a network device.

In some example embodiments, an apparatus capable of performing the method 300 (for example, implemented at the UE 110) may comprise means for performing the respective steps of the method 300. The means may be implemented in any suitable form. For example, the means may be implemented in a circuitry or software module.

In some example embodiments, the apparatus comprises means for determining receive timing difference between a serving cell of the first device and a target cell, the serving cell being located on a first carrier, the target cell being located in a second carrier; and means for determining to report an indication associated with the receive timing difference to the second device.

In some example embodiments, an apparatus capable of performing the method 400 (for example, implemented at the gNB 120-1) may comprise means for performing the respective steps of the method 400. The means may be implemented in any suitable form. For example, the means may be implemented in a circuitry or software module.

In some example embodiments, the apparatus comprises means for in accordance with a determination that an indication associated with the receive timing difference between a serving cell of a first device and the target cell is received from the first device, determining an availability of the target cell based on the indication, the serving cell being located on a first carrier, the target cell being located in a second carrier.

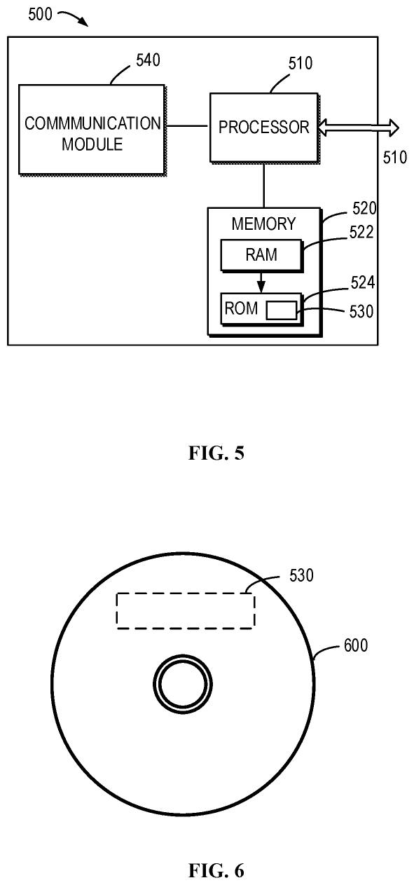

FIG. 5 is a simplified block diagram of a device 500 that is suitable for implementing embodiments of the present disclosure. The device 500 may be provided to implement the communication device, for example the UE 110 as shown in FIG. 1. As shown, the device 500 includes one or more processors 510, one or more memories 520 coupled to the processor 510, and one or more communication modules 540 coupled to the processor 510.

The communication module 540 is for bidirectional communications. The communication module 540 has one or more communication interfaces to facilitate communication with one or more other modules or devices. The communication interfaces may represent any interface that is necessary for communication with other network elements. In some example embodiments, the communication module 540 may include at least one antenna.

The processor 510 may be of any type suitable to the local technical network and may include one or more of the following: general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

The memory 520 may include one or more non-volatile memories and one or more volatile memories. Examples of the non-volatile memories include, but are not limited to, a Read Only Memory (ROM) 524, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 522 and other volatile memories that will not last in the power-down duration.

A computer program 530 includes computer executable instructions that are executed by the associated processor 510. The program 530 may be stored in the ROM 524. The processor 510 may perform any suitable actions and processing by loading the program 530 into the RAM 520.

The embodiments of the present disclosure may be implemented by means of the program 530 so that the device 500 may perform any process of the disclosure as discussed with reference to FIGS. 2 to 4. The embodiments of the present disclosure may also be implemented by hardware or by a combination of software and hardware.

In some example embodiments, the program 530 may be tangibly contained in a computer readable medium which may be included in the device 500 (such as in the memory 520) or other storage devices that are accessible by the device 500. The device 500 may load the program 530 from the computer readable medium to the RAM 522 for execution. The computer readable medium may include any types of tangible non-volatile storage, such as ROM, EPROM, a flash memory, a hard disk, CD, DVD, and the like. FIG. 6 shows an example of the computer readable medium 600 in form of CD or DVD. The computer readable medium has the program 530 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 300 and 400 as described above with reference to FIGS. 3-4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-37. (canceled)

38. A first device comprising:
at least one processor; and
at least one memory including computer program codes;
the at least one memory and the computer program codes are configured to, with the at least one processor, cause the first device at least to:
determine receive timing difference between a serving cell of the first device and a target cell, the serving cell being located on a first carrier, the target cell being located in a second carrier; and
determine to report an indication associated with the receive timing difference to the second device.

39. The first device of claim 38, wherein the first device is caused to determine to report the indication associated with the receive timing difference by:
determining the indication associated with the receive timing difference is to be reported to the second device, in accordance with a determination of at least one of the following:
an inter-frequency measurement or an intra-frequency measurement before the target cell on the second carrier is being used in a carrier aggregation is to be reported;
a carrier aggregation is configured for the first device;
the target cell is configured for the first device as a secondary cell;
the target cell is being-activated;
the determined receive timing difference exceeds a threshold value;
a request by the second device; and
the determined receive timing difference is equal to or lower than the threshold value.

40. The first device of claim 38, wherein the first device is caused to determine to report the indication associated with the receive timing difference by:
in accordance with a determination that the determined receive timing difference fails to exceed a threshold value, causing the reporting of the determined receiving time difference to be skipped; or
in accordance with a determination that the determined receive timing difference exceeds a threshold value, causing the indication associated with the receive timing difference to be skipped; or
in accordance with a determination that the determined receive timing difference exceeds a threshold value, causing the measurement reports associated with the target cell not to be skipped.

41. The first device of claim 39, wherein the threshold value comprises at least one of the following:
a predefined common threshold value,
a threshold value specified for the first device, or
a threshold determined by the first device.

42. The first device of claim 41, wherein the threshold value specified for the first device or the threshold determined by the first device is located within a range between the predefined common threshold value and a predefined maximum receive timing difference of the first device.

43. The first device of claim 41, wherein the threshold value specified for the first device or the threshold determined by the first device is set to being not lower than 260 ns.

44. The first device of claim 38, wherein the first device is further caused to:
generate the indication associated with receive timing difference comprising at least one of the following:
a value of the determined receive timing difference, or
an indication of potential impact due to performance degradation of a carrier aggregation; or
an indication that receive timing difference is above/below a threshold value.

45. The first device of claim 38, wherein the first device is further caused to:
transmit the indication associated with receive timing difference to the second device via at least one of the following:
channel state information reporting for the target cell;
a reporting associated with reference signal received power of the target cell;
a beam failure detection or indication on the target cell; or
a layer 3 measurement report.

46. The first device of claim 38, wherein the first device is caused to determine the receive timing difference by:
in accordance with a determination that the first device is indicated to report the receive timing difference, determining the receive timing difference.

47. The first device of claim 38, wherein the first device is caused to determine the receive timing difference by:
receiving a measurement configuration of the target cell from the second device; and
determining the receive timing difference based on the measurement configuration.

48. The first device of claim 38, wherein the first device comprise a terminal device and the second device comprises a network device.

49. A second device comprising:
at least one processor; and
at least one memory including computer program codes;
the at least one memory and the computer program codes are configured to, with the at least one processor, cause the second device at least to:
in accordance with a determination that an indication associated with the receive timing difference between a serving cell of a first device and the target cell is received from the first device, determine an availability of the target cell based on the indication, the serving cell being located on a first carrier, the target cell being located in a second carrier.

50. The second device of claim 49, wherein the second device is further caused to:
transmit a measurement configuration of the target cell to the first device.

51. The second device of claim 49, wherein the second device is further caused to:
obtain, from the indication, at least one of the following:
a value of the determined receive timing difference, or
an indication of potential impact due to performance degradation of a carrier aggregation; or
an indication that receive timing difference is above/below a threshold value.

52. The second device of claim 49, wherein the second device is caused to receive the indication via at least one of the following:
channel state information reporting for the target cell;
a reporting associated with reference signal received power of the target cell;
a beam failure indication on the target cell;
a layer 3 measurement report.

53. The second device of claim 49, wherein the second device is further caused to:
indicate the first device to report the receive timing difference to the second device.

54. The second device of claim 38, wherein the first device comprise a terminal device and the second device comprises a network device.

55. A method comprising:
determining receive timing difference between a serving cell of the first device and a target cell, the serving cell being located on a first carrier, the target cell being located in a second carrier; and
determining to report an indication associated with the receive timing difference to the second device.

56. The method of claim 55, wherein determining to report the indication associated with the receive timing difference comprises:
determining the indication associated with the receive timing difference is to be reported to the second device, in accordance with a determination of at least one of the following:
an inter-frequency measurement or inter-frequency measurement before the target cell on the second carrier is being used in a carrier aggregation is to be reported;
a carrier aggregation is configured for the first device;
the target cell is configured for the first device as a secondary cell;
the target cell is being-activated;
the determined receive timing difference exceeds a threshold value;
a request by the second device; and
the determined receive timing difference is equal to or lower than the threshold value.

57. The method of claim 55, wherein determining to report the indication associated with the receive timing difference comprises:
in accordance with a determination that the determined receive timing difference fails to exceed a threshold value, cause the reporting of the determined receiving time difference to be skipped; or in accordance with a determination that the determined receive timing difference exceeds a threshold value, causing the indication associated with the receiving time difference to be skipped; or
in accordance with a determination that the determined receive timing difference exceeds a threshold value, causing the measurement reports associated with the target cell not to be skipped.
